(19) United States
(12) Patent Application Publication
(10) Pub. No.: US 2005/0111556 A1
(43) Pub. Date: May 26, 2005

(54) System and method for real-time decompression and display of Huffman compressed video data

(76) Inventors: William B. Endress, Tucson, AZ (US); George G. Descamps III, Tucson, AZ (US)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/722,762

(22) Filed: Nov. 26, 2003

(51) Int. Cl. H04N 7/12

(52) U.S. Cl. 375/240.23; 375/240.28

(57) ABSTRACT

A method is provided for performing real-time decompression and display of Huffman compressed video data. The method includes implementing a personal computer to carry out the steps of receiving the video data; searching for a frame synchronizing code on bit boundaries of the video data; upon detecting the frame synchronizing code for a given frame in the video data, extracting a frame number, Huffman levels and corresponding intensities from the given frame; extracting pixel data for the given frame based on the Huffman levels and corresponding intensities; and displaying the pixel data in real time.

### TECHNICAL FIELD

The present invention relates generally to decompressing Huffman encoded data, and more particularly to a system and method for decompressing and displaying Huffman encoded video data in real-time.

### BACKGROUND OF THE INVENTION

As is well-known, Huffman coding is a popular variable length statistical encoding scheme. As is also well-known, Huffman code generation relies on statistical probabilities for each individual symbol. See, for example, D. A. Huffman, “A Method for the Reconstruction of Minimum-Redundancy Codes” Proceedings of the IRE, Volume 40, No. 9, pages 1098-1101, 1952. A traditional table lookup based encoding scheme is widely used for Huffman encoding due, at least in part, to its efficiency and relative ease of implementation. However, table searching based decoding is typically inefficient in both software and hardware implementations. This is especially the case when the number of entries in a table is reasonably high, as is typical for practical applications. Another approach employed for Huffman decoding is the creation of a Huffman tree which employs a “tree traversing technique.” However, this decoding technique also has disadvantages. This particular technique is bit sequential, and introduces extra “overhead” both in terms of memory allocation and the execution of computations for the Huffman tree generation process and for the decoding process.

In digital video data transmission systems, video data is encoded prior to being transmitted to a receiver. The receiver, in turn, decodes the encoded digital video data. The decoded digital video data is then output to a subsequent signal processing stage. To increase the data throughput and memory efficiency in such systems, statistical compression algorithms are used to compress and encode the digital video data. One such compression algorithm is the Huffman coding algorithm. Compressing the data typically results in data streams segmented into variable length code words rather than fixed length code words. Variable length decoders decode the variable length code words comprising the compressed data stream.

Unfortunately, there have been drawbacks associated with utilizing Huffman coding to transmit video data. In order to decode a compressed video data signal in real time (i.e., at 30 frames/second or greater), typically in the past parallel decoders and/or very high-speed processors were necessary. Typical personal computers were unable to decode the video data in real time.

In view of the aforementioned shortcomings associated with conventional techniques for decompressing Huffman encoded video data, there is a strong need in the art for a system and method suitable for decompressing and displaying Huffman encoded video data in real-time. In particular, there is a strong need in the art for a system which may be suitably carried out on a conventional personal computer having a typical microprocessor (e.g., a 2.4 GHz Intel Pentium® or the like). Moreover, there is a strong need in the art for such system in which the personal computer may be programmed using an off-the-shelf higher level programming language such as Visual Basic.

### SUMMARY OF THE INVENTION

According to one aspect of the invention, a method is provided for performing real-time decompression and display of Huffman compressed video data. The method includes implementing a personal computer to carry out the steps of receiving the video data; searching for a frame synchronizing code on bit boundaries of the video data; upon detecting the frame synchronizing code for a given frame in the video data, extracting a frame number, Huffman levels and corresponding intensities from the given frame; extracting pixel data for the given frame based on the Huffman levels and corresponding intensities; and displaying the pixel data in real time.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is an environmental view illustrating use of a system and method for decompressing and displaying Huffman encoded video data in real-time in accordance with the present invention;

FIG. 2 is a block diagram of the system for decompressing and displaying Huffman encoded video data in real-time in accordance with the present invention;

FIG. 3 is a flowchart suitable for programming a computer to carrying out the decompression and display of Huffman encoded video data in real-time in accordance with the present invention;

FIG. 4 is a flowchart suitable for programming a computer to detect and skip fill data as part of a search routine for searching for a frame synchronizing code in accordance with the present invention;

FIG. 5 is a flowchart suitable for programming a computer to check for a synchronizing code across bit boundaries according to a conventional technique;

FIG. 6 is a flowchart suitable for programming a computer to check for a synchronizing code across bit boundaries in accordance with the present invention;

FIG. 7 is a flowchart suitable for programming a computer to extract the frame number of the video frame, Huffman levels, and corresponding intensities according to a conventional technique;

FIG. 8 is a flowchart suitable for programming a computer to extract the frame number of the video frame, Huffman levels, and corresponding intensities in accordance with the present invention;

FIG. 9 is a flowchart suitable for programming a computer to extract the Huffman codes from the video frame and associate them with an intensity level according to a conventional technique.

FIG. 10 is a flowchart suitable for programming a computer to extract the Huffman Codes from the video frame and associate them with an intensity level in accordance with the present invention; and

FIG. 11 represents a flowchart suitable for programming a computer to carry out a routine to extract all the pixel data from the compressed video frame in accordance with the present invention.

### DETAILED DESCRIPTION OF THE INVENTION

The present invention will now be described with reference to the drawings, wherein like reference numerals refer to like elements throughout.

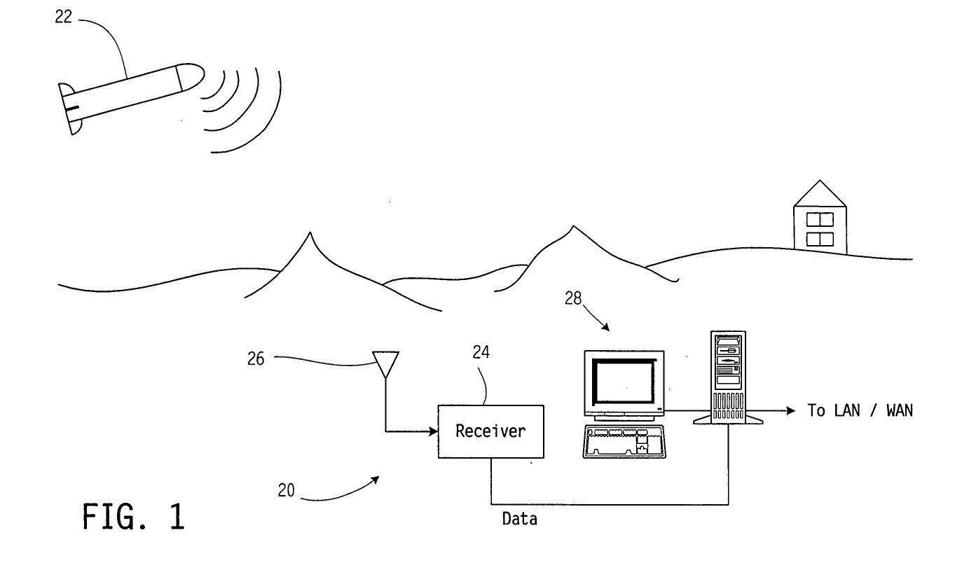

Referring initially to FIG. 1, an environmental view representing an exemplary utility of the present invention is shown. In FIG. 1, a system 20 is shown for providing real-time decompression and display of Huffman compressed video data in accordance with the present invention. In the exemplary embodiment, the system 20 receives video telemetry data from a missile 22 while in transit. The system 20 may be located at a ground base station, within a mobile unit, etc.

As is shown in FIG. 1, the missile 22 is designed to transmit Huffman compressed video telemetry data via high-frequency radio signals to a receiver 24 included within the system 20. The receiver 24 includes an antenna 26 for receiving the radio signals which are then downconverted to produce a digital data signal representing the Huffman compressed video data provided by the missile 22. The system 20 further includes a computer 28 or other system processor for processing the video data in order to display the data.

According to one feature of the invention, the computer 28 may be a conventional, low-cost personal computer (PC). As is described more fully below, the present invention permits a conventional PC having a readily commercially available processor (e.g., an Intel Pentium IV at 2.4 GHz or greater) to execute software in accordance with the invention to decompress and display the video data in real time (e.g., at a frame decompression rate of 30 frames per second or greater). There is no need for extensive and expensive hardware. Thus, it becomes more cost effective to employ multiple systems 20 throughout a region, etc.

As is further shown in FIG. 1, the computer 28 may be connected to a local area network (LAN) and/or a wide area network (WAN) via a wired or wireless connection, for example. According to another feature of the invention as described more fully below, the system 20 may receive data inputs from multiple sources via the LAN/WAN. Such data inputs may be other video data, tracking information, etc. Also, the invention provides for the display of such tracking information and other text information in real time by overlaying such data onto the decompressed video data. Furthermore, the decompressed video data may be made up of multiple different sources of video. The system 20 allows for simultaneous display of the different video sources within a single instance. Moreover, the system is capable of recording the thus developed realtime imagery to a digital file for playback at a later time.

The system 20 is described herein in connection with the real time decompression and display of Huffman compressed video telemetry data. However, it will be appreciated that the present invention is not limited to use with telemetry data. The present invention has utility with respect to virtually any Huffman compressed video data which is desirable of being displayed in real time. Accordingly, while the invention is described with respect to telemetry video data, the invention is intended to apply to the decompression and display of any type of video data.

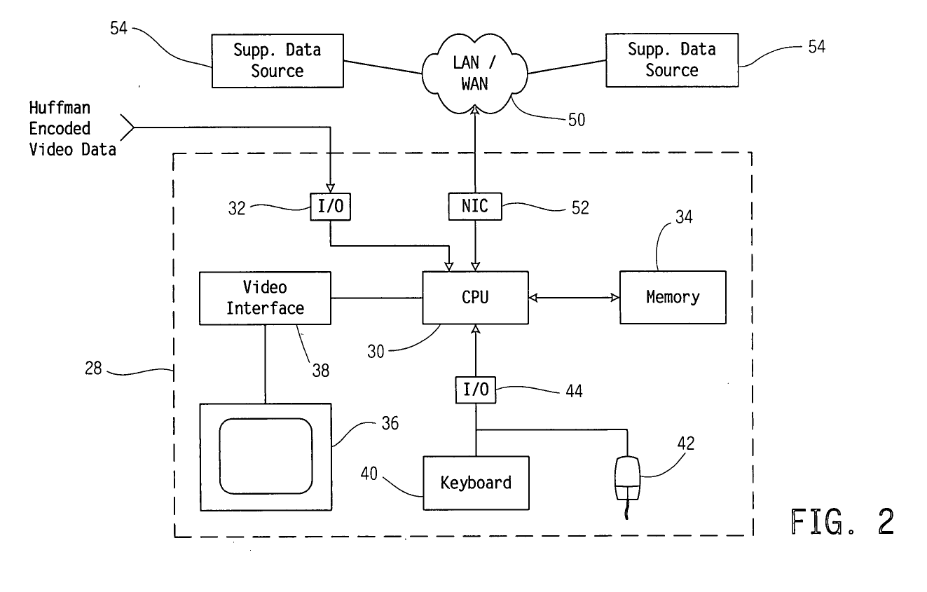

Referring now to FIG. 2, a block diagram of the computer 28 is shown in accordance with the exemplary embodiment of the invention. As noted above, the computer 28 may be a conventional personal computer (PC) architecture as shown. The computer 28 is programmed using a conventional higher level programming language (e.g., Visual Basic) to carry out the various functions described herein. Based on the description provided herein, those having ordinary skill in the art of computer programming will understand how to program and use the computer 28 in accordance with the invention without undue effort and experimentation. Accordingly, details regarding the particular computer program and code executed by the computer 28 have been omitted for sake of brevity.

The computer 28, as shown in FIG. 2, includes a central processing unit (CPU) 30. The CPU 30 executes machine readable code compiled from a computer program in accordance with the invention. In executing such code, the CPU 30 processes the Huffman compressed data received from the receiver 24 via an input/output (I/O) interface 32. Specifically, the CPU 30 decompresses and displays the video telemetry data in real time. The CPU 30 preferably is a low-cost commercially well-available microprocessor such as the Intel Pentium 4 with a clock speed of 2.4 Ghz or greater. Of course, the CPU 30 could be any similar processor available, for example, from Advanced Micro Devices (AMD) such as the Athalon processor, or from Motorola.

The computer 28 further includes a memory 34 coupled to the CPU 30 for storing machine-readable information and data such as the operating system (e.g., Windows XP), application programs including a program in accordance with the invention, application data, etc. As is well known, the memory 34 may be made up of a combination of read-only memory (ROM), random-access memory (RAM), etc. Moreover, the memory 34 may include non-volatile memory such as conventional ROM, magneto, optical or magneto-optical storage devices such as hard drives and/or optical disk drives, flash EEPROM memory, etc. In addition, the memory 34 may include volatile memory such as conventional RAM. The RAM preferably serves as working memory for carrying out the various processing described herein as will be appreciated.

In addition, the computer 28 includes a video display 36 coupled to the CPU 30 via a video interface (e.g. video card) 38. Upon decompressing the video telemetry data provided by the receiver 24 (FIG. 1), the CPU 30 in turn displays the data in real time so that a user may take appropriate action in view of such data. The computer 28 also may include various user input devices such as a keyboard 40 and mouse 42, for example. The keyboard 40 and mouse 42 are coupled to the CPU 30 via a conventional I/O interface 44 as will be appreciated. Via user commands input via the keyboard 40 and/or the mouse 42, for example, a user is able to instruct the CPU 30 to open and execute a program stored in the memory 34 for decompressing and displaying the video telemetry data in accordance with the invention.

Furthermore, the computer 28 may be coupled to one or more other computers, devices, servers, etc. via a LAN and/or WAN 50 using conventional networking techniques. The CPU 30 is coupled to the LAN/WAN 50 via a network interface card (NIC) 52, for example. Other devices coupled to the LAN/WAN 50 may include one or more supplemental data sources 54. Such sources 54 may themselves provide Huffman compressed video data to the computer 28 in order to be decompressed and displayed in real time. In addition, or in the alternative, one or more sources 54 may provide other types of data which may be displayed with the decompressed video telemetry data from the receiver 24. For example, the supplemental data sources 54 may provide target tracking information or other data associated with the flight of the missile 22. The present invention provides a manner for overlaying the decompressed video data with the supplemental data in order to display each on the display 26.

In the exemplary embodiment described herein, the video telemetry data provided by the missile 22 contains an array of 256 pixels×256 pixels making up a frame of 65,536 pixels. The video telemetry data has been compressed using the Huffman compression algorithm. In addition to video data, the telemetry data may include certain object tracking parameters that need to be displayed. Decompressing and displaying video data in real time is defined herein to be displaying video frames at the rate of 30 frames per second or greater on a 2.4 GHz or greater desktop Personal Computer (PC).

Huffman compression allows for video pixel intensity data to be represented by as few as a single bit of binary data. As a result, extracting images composed of 65,536 pixels are very computationally intensive, and not well suited for high level languages. The present invention presents a software technique that can decompress Huffman compressed data at a rate of 30 frames or better on a 2.4 GHz. PC computer 28 using Visual Basic, for example. This technique takes advantage of both the PC hardware within the computer 28, and the efficiency of the Visual Basic compiler running on the computer 28.

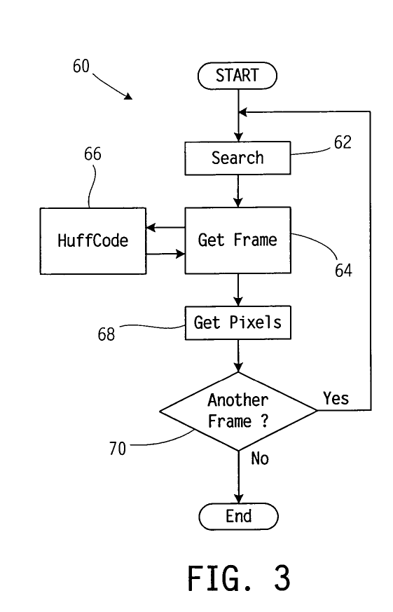

The computer 28 is programmed in accordance with the invention to decompress the Huffman compressed data received from the receiver 24 in accordance with the process 60 shown in FIG. 3. Generally speaking, the process 60 involves stripping one or more bits from a digital word of the Huffman compressed data, comparing the stripped bit or bits with a list of valid intensities, and assigning the valid intensity to a pixel. Because valid pixel data can be represented by as little as a single bit, the data is bit asynchronous. Therefore, all the processing to decompress the imagery data operates on bit boundaries. As will be appreciated based on the disclosure herein, the processing is composed of non-standard and counter-intuitive programming techniques that take advantage of the processor hardware, and optimization techniques of the compiler, to achieve the speed necessary for real time execution using a high level language. This includes reducing the number of called subroutines to four, resulting in fewer steps added to jump to a routine address.

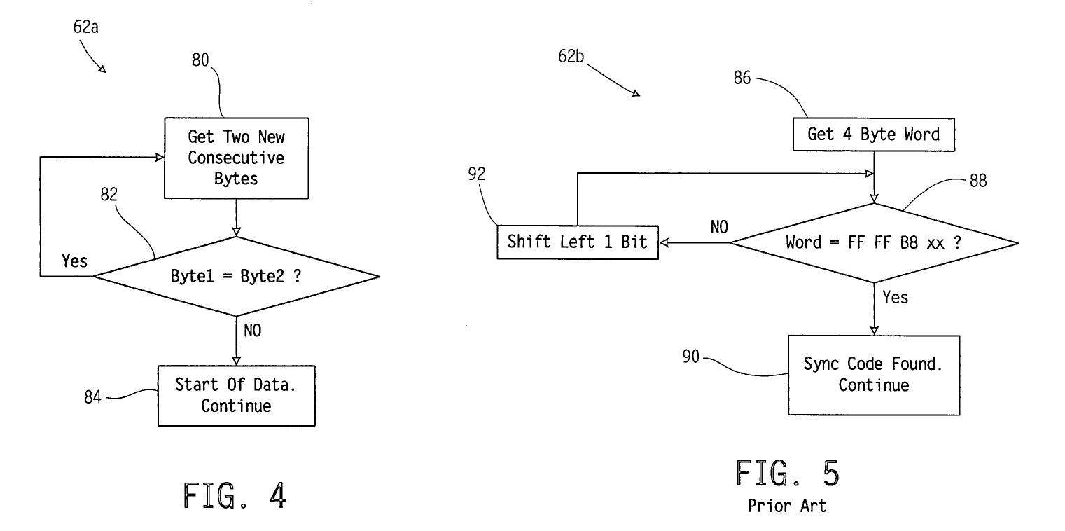

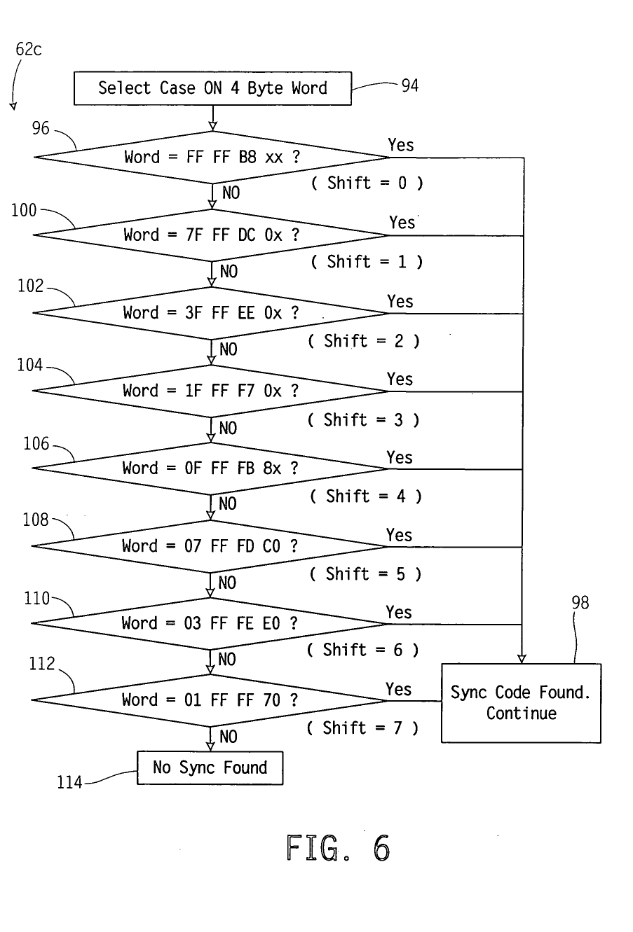

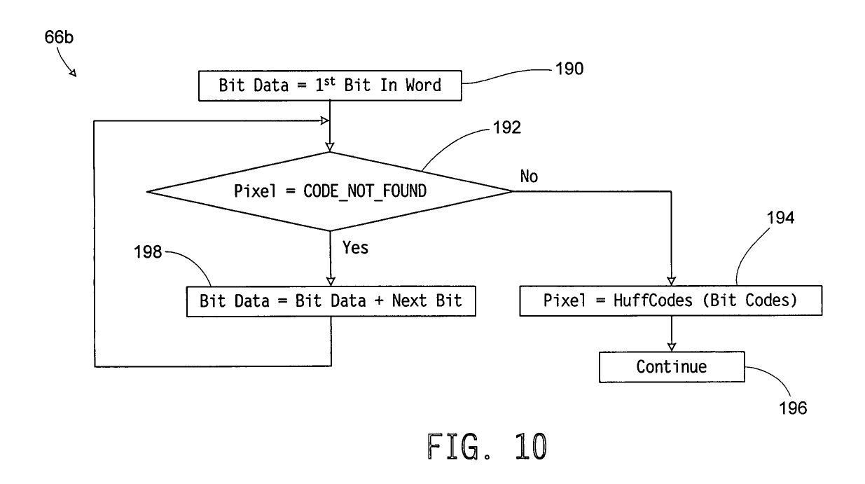

More specifically, the computer 28 first executes a Search subroutine 62 in which the computer 28 searches for a frame synchronizing code on bit boundaries. The Search subroutine 62 is described more fully below in connection with FIGS. 4 and 6. Once a frame synchronizing code has been found in the compressed data for a given frame, the Search subroutine 62 calls a GetFrame routine 64 that extracts the frame number of the video frame, Huffman levels, and corresponding intensities from the frame of compressed data. The GetFrame routine 64, which is described in more detail below in relation to FIG. 8, calls a HuffCode routine 66. The HuffCode routine 66 extracts the Huffman Codes and associates them with an intensity level, and returns to the GetFrame routine. The HuffCode routine 66 is described in more detail below in relation to FIG. 10.

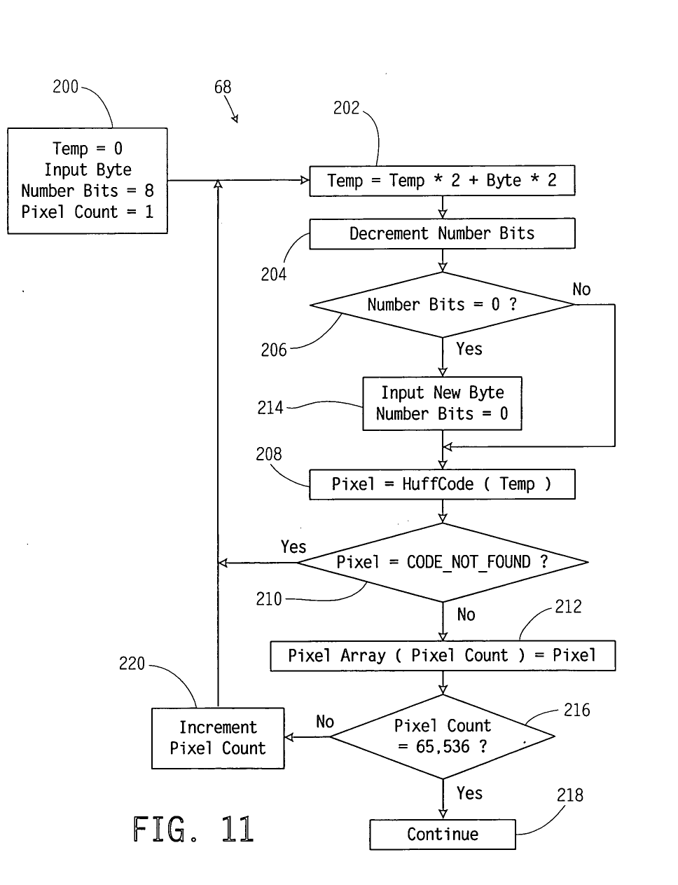

The fourth routine, referred to herein as GetPixels 68, extracts all 65,536 pixels from the frame of compressed data. Because the GetPixels routine 68 is computational intensive, preferably it calls no subroutines. This results in a lengthy routine with much of the code repetitive in order to increase execution speed. In addition to minimizing the number of subroutine calls, all variables are declared globally. This reduces the time needed to instantiate local variables at the start of the routine, and the release of these variables at the completion of the routine. The GetPixels routine 68 is described below in relation to FIG. 11.

Following the GetPixels routine 68, the computer 28 in step 70 determines if additional frames exist by virtue of the receiver 24 continuing to provide Huffman compressed data. If yes, the computer 28 returns to the Search routine 62 and repeats the above-described process. Else, the process ends.

Referring now to FIGS. 4-6, the Search routine 62 will now be described in more detail. As the Huffman compressed video data is input to the computer 28 from the receiver 24, the computer 28 executes the Search routine 62 and searches for a frame synchronizing code on bit boundaries of the compressed video data. To do this the computer 28 must first skip fill data which is included between compressed frames of video data. In the exemplary embodiment, fill data is represented by a series of consecutive duplicate eight bit data bytes. The computer 28 is programmed to input and compare two consecutive data bytes of the Huffman compressed data. If the bytes are identical, both are discarded as fill data. If they are not identical, the computer 28 is programmed to examine the consecutive data bytes to see if they are part of a predefined four byte synchronizing code. The following fragment of pseudo-code demonstrates the above steps:

| | | |
|---|---|---|
| (1) | Loop: | Input Byte |

| Input Byte +1 | |
|---|---|
| If Byte = Byte + 1 | |
| | Repeat Loop |
| Else | |
| | Input Byte +2 |
| | Input Byte +3 |

FIG. 4 illustrates formula (1) and the manner in which fill data is detected and skipped in order to detect the beginning of the valid data. Specifically, in step 80 the computer 28 inputs two new consecutive bytes of Huffman compressed video data from the receiver 24. In step 82, the computer 28 detects whether the two consecutive bytes of data are identical (Byte1=Byte2). If yes, the two consecutive data bytes are discarded and the computer 28 returns to step 80. If no in step 82, the beginning of non-fill, or valid, compressed data is detected as represented in step 84.

The common method of checking for a synchronizing code across bit boundaries is to compare the known code with the input data. If the code compares successfully, processing continues. If the compare fails, the data is shifted left one bit and compared again. This process continues until all eight combinations are tried. The following Pseudo-code demonstrates checking for a synchronizing code of FF FF B8 (Hexidecimal). In all the following examples, x indicates don't care information:

(2) Loop: If (Byte, Byte1, Byte2, Byte3) not equal to (FF FF B8

xx) then

```
              Shift Right 1 Bit (Byte, Byte1, Byte2, Byte3)
              Shift = Shift + 1
              Repeat Loop
```

FIG. 5 is a flowchart illustrating above common method represented by formula (2). In step 86, the computer 28 is programmed to obtain a four byte word of data from the input data following detection of the non-fill data. If the word is equal to FF FF B8 xx as determined in step 88, the synchronization code is thus detected as represented in step 90. If the word does not equal FF FF B8 xx as determined in step 88, the computer 28 shifts left one bit as represented in step 92. The computer 28 then returns to step 88 to determine if the new four byte word is equal to FF FF B8 xx. The process continues until the synchronization code is detected.

Another and faster method of checking for the synchronization code across bit boundaries is to compare the data against a known bit configuration. While the number of lines of code executed by the computer 28 is greater, it avoids the overhead of the jumps required in a loop. This construct also compiles into a tighter executable file for the computer 28. The following fragment of pseudo-code demonstrates this:

| | | | |
|---|---|---|---|
| (3) | Loop: Select | Case | (Byte, Byte +1, Byte +2 Byte +3) |

| | |
|---|---|
| Case: | FF FF B8 xx ‘Valid Sync Code |
| | Shift = 0 |
| Case: | 7F FF DC 0x ‘Valid Sync Code |
| | Shift = 1 |
| Case: | 3F FF EE 0x ‘Valid Sync Code |
| | Shift = 2 |
| Case: | 1F FF F7 0x ‘Valid Sync Code |
| | Shift = 3 |
| Case: | 0F FF FB 8x ‘Valid Sync Code |
| | Shift = 4 |
| Case: | 07 FF FD C0 ‘Valid Sync Code |
| | Shift = 5 |
| Case: | 03 FF FE E0 ‘Valid Sync Code |
| | Shift = 6 |
| Case: | 01 FF FF 70 ‘Valid Sync Code |
| | Shift = 7 |
| Case | Else |
| | ‘Select failed |
| | Byte = Byte + 1 |
| | Byte + 1 = Byte + 2 |
| | Byte + 2 = Byte + 3 |
| | Input Byte + 3 |
| | Repeat Loop |

FIG. 6 is a flowchart illustrating the faster routine of formula (3) for checking for the synchronization code in accordance with the present invention. In step 94, the computer 28 again obtains a four byte word of data from the input data following detection of the non-fill data. Next, in step 96 the computer 28 determines if the word is equal to FF FF BB xx. If yes, the computer 28 has detected the synchronization code and thus proceeds to step 98. If no in step 96, the computer checks whether the word is equal to 7F FF DC 0x in step 100. If yes, the computer 28 has detected the synchronization code and proceeds to step 98. If no in step 100, the computer 28 proceeds to step 102 in which it determines whether the word is equal to 3F FF EE 0x. This process is repeated in steps 104, 106, 108, 110 and 112 comparing the four byte word to 1F FF F7 0x, 0F FF FB 8x, 07 FF FD C0, 03 FF FE E0, and 01 FF FF 70, respectively. If the word is identical in any of such steps, the synchronization code is found as represented in step 98. If not, the computer 28 proceeds to step 114 in which it is concluded that no synchronization code is found. In the event no synchronization code is found as determined in step 114, the process is repeated for the next four byte word as represented in step 94.

It will be appreciated that in FIG. 5, code is written to perform an actual 1 bit shift on the input data. This shift is repeated in a loop. FIG. 6 uses a ‘Case’ statement to perform a virtual shift on the data. As for the ‘CASE’ statement, this is one of several language constructs that became available with the advent of structured languages. It is similar in construct to a series of nested ‘IF’ statements. The big difference is that the case statement is complied down to a much more efficient set of steps for the processor to execute. The ‘CASE’ statement, as well as other structured language statements, do not lend themselves well to flow charting. Note the convolutions that are done in FIG. 6, which is equivalent to formula (3). If in fact one were to follow the flow chart, one might be tempted to use nested “IF” statements leading to inefficiencies in the compiled code.

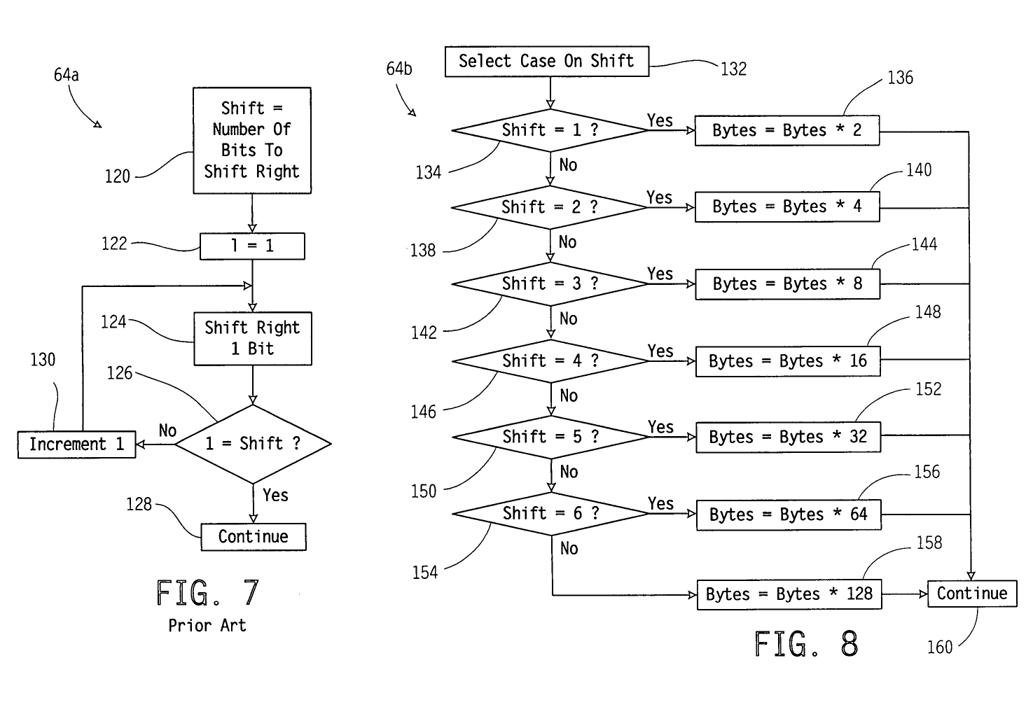

Once the computer 28 detects a valid synchronization code via the process of FIG. 6, the computer 28 proceeds to the GetFrame routine 64 as represented in FIGS. 7 and 8. In the exemplary embodiment, the GetFrame routine 64 uses a variable Shift to determine the number of bits the data has been shifted to the left in detecting the valid synchronization code in the Search routine 62. The entire block of video data, including Huffman codes, frame number and pixel intensity values has been shifted in the incoming data by the number of bits represented by the variable ‘shift’ in formula (3). The following formulas uses this shift information in order to extract valid bytes of data from the current video frame.

| | |
|---|---|
| (4) | Input n Bytes |
| | For I = 1 to Shift ‘Number of bits shifted |
| | Shift Right 1 Bit (n Bytes) |
| | Next I |

FIG. 7 is a flowchart representing the traditional manner of formula (4). In step 120, the variable “Shift” is set equal to the number of bits by which the computer 28 needs to shift the data to the right. In the case of the process of FIG. 5, the value of Shift is set equal to the number of times step 92 was encountered for a given frame of data. In the case of the process of FIG. 6, the value of Shift is set equal to 0 thru 7, depending on which of the conditions in steps 96, 100, 102, 104, 106, 108, 110 and 112, respectively, are satisfied.

Continuing to refer to FIG. 7, in step 122 the counter variable I is set equal to one. Next, in step 124 the computer 28 shifts the data for the given frame to the right by 1 bit. In step 126, the computer 28 determines whether I is equal to Shift. If yes, the data has been successfully shifted and the process continues as represented in step 128. If not in step 126, the value of I is incremented by 1 in step 130. The computer 28 then returns to step 124 where the data is again shifted to the right by one bit, etc.

A faster approach in accordance with the invention takes advantage of the efficiency of the hardware and the optimizing techniques of the software compiler within the computer 28. Specifically, the technique involves doing an integer multiply of the bytes by a power of two. In the following example, the numbers 2, 4, 8,16, 32, 64 and 128 are the powers of two for 1 through 7.

| | |
|---|---|
| (5) | Select Case on Shift |

| | |
|---|---|
| Case: | 1 |
| | Bytes * 2 |
| Case: | 2 |
| | Bytes * 4 |
| Case: | 3 |
| | Bytes * 8 |
| Case: | 4 |
| | Bytes * 16 |
| Case: | 5 |
| | Bytes * 32 |
| Case: | 6 |
| | Bytes * 64 |
| Case: | 7 |
| | Bytes *128 |

As represented in FIG. 8, in step 132 the computer 28 determines the value of the variable Shift as described above from the process of FIG. 6. If the value of Shift is equal to one as determined in step 134, the computer 28 shifts the frame data to the right by one bit by multiplying the data by two as represented in step 136. Similarly, if the value of Shift is equal to two as determined in step 138, the data is shifted to the right by two bits by multiplying the data by 4 as represented in step 140. Steps 142 and 144 effect a shift of three bits; steps 146 and 148 effect a shift of four bits, steps 150 and 152 effect a shift of five bits, and so on. Thus, by doing an integer multiply of the bytes by a power of two corresponding to the value of Shift, the computer 28 quickly and efficiently shifts the data to the right so that the process may continue as represented by step 160.

In the continue process step 160 of the GetFrame routine, the frame number of the given frame being processed is extracted together with the Huffman levels and corresponding intensities. Since such data is not compressed in the compressed data received from the receiver 24, the computer 28 is able to simply extract such information using conventional techniques upon aligning the bits as in FIG. 6.

Once the levels and intensities have been extracted using the above GetFrame routine 66, the computer 28 calls the HuffCode routine 64 to build an array of Huffman codes from the frame data. It is noted that the conventional Huffman array algorithm builds an array of Huffman codes with one code for each element. During the bit decompression process, a bit value is decoded and compared to the values in the array. When a match is found, the index to the matching code is used as the index into the intensity array. The following pseudo-code is an example of this conventional process:

| | | ‘Search through Huffman codes to find a match |
|---|---|---|
| (6) | Loop: | Get Bit Data |

For I = 0 to Number of Huffman Codes − 1

If Bit Data = HuffCodes (I) Then

Pixel = Intensity (I)
Exit Loop

Else

CODE_NOT_FOUND
Loop ‘Get another bit to compare

Next I

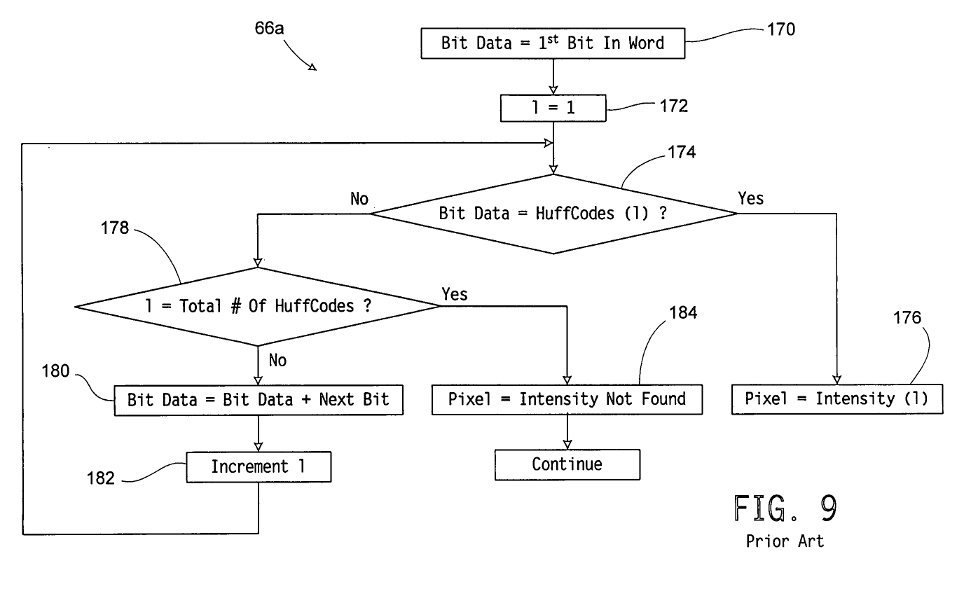

FIG. 9 is a flowchart illustrating the pseudo-code of Formula (6). In step 170, the variable “Bit Data” is set equal to the first bit in a frame data word being decompressed. Next, in step 172 the counter I is set equal to one. Thereafter, in step 174 the computer 28 determines if the Bit Data is equal to any of the Huffman Codes (I) in the array. If yes, the Bit Data matches the Huffman Code and the Intensity (I) associated with the matching Huffman Code is associated with the corresponding pixel within the frame data as represented in step 176.

If in step 174 the Bit Data is not equal to any of the Huffman Codes in the array, the computer 28 proceeds to step 178 in which it is determined whether I is greater than the number of Huffman Codes in the array. If no, the Bit Data is set equal to the previous Bit Data plus the next bit in the data being decompressed, as represented in step 180. The counter I is incremented by one in the following step 182, and the computer 28 returns to step 174 as shown. In step 174, the new Bit Data value is compared with the Huffman Codes in the array. If there is a match, the computer 28 proceeds to step 176. Else, steps 178, 180, etc. are repeated. In the event the counter I in step 178 does equal the total number of Huffman codes in the array, this indicates that the intensity of the corresponding pixel cannot be-found as represented in step 184. The process of FIG. 9 would then be repeated for each of the pixels in the compressed frame data.

By using a much larger array (256 values), during the generation of the Huffman Codes the decoded code can be used as an index into the array, and the corresponding intensity can be assigned the value of the array at that location. Locations for which there are no valid Huffman Codes are preset to the value CODE_NOT_FOUND. The intensity assignment can now be made once per frame, rather than once per pixel. The following pseudo-code replaces the above code of formula (6):

| | | |
|---|---|---|
| (7) | Loop: | Get Bit Data |
| | | Pixel = HuffCodes (Bit Data) |
| | | Loop While Pixel = CODE_NOT_FOUND |

FIG. 10 is a flowchart representing the process of Formula (7) which is used in the present invention to improve processing in associating pixel intensities. For Huffman Codes using 8-bit values, there are a possible 256 different intensities. Depending on efficiency of the compression algorithm and the type of background of the video data, not all 256 intensities need be used. For example, in the case of telemetry data the video is mostly the blackness of space with a few stars. Because there is high uniformity in the background data and typically very little contrast in such case, very few of the available codes are used (e.g., only around 20 or so).

In accordance with the invention, all 256 values in the array are initialized with the flag “Code_Not_Found”. When the Huffman codes and intensities are initially extracted, the “Code_Not_Found” is overwritten with a valid intensity.

In step 190, the variable “Bit Data” is set equal to the first bit in a frame data word being decompressed. Next, in step 192 the computer 28 determines whether a variable “Pixel” is still preset to “Code_Not_Found”. If no in step 192, this means the pixel intensity is equal to the Huffman code in the array indexed by the Bit Data as shown in step 194. The process then continues for the next pixel in the frame data as represented in step 196.

If in step 192 the variable Pixel does equal Code_Not_Found, the Bit Data is updated by adding the next bit in the word to the previous Bit Data as represented in step 198. The process then returns to step 192 and the above steps are then repeated. Such process is then repeated for the pixel intensity data for each of the pixels in the frame.

Following the above-described Huffcode routine 66, the computer 28 proceeds to the GetPixels routine 68 to extract the 65,536 pixels from the data. The process is to shift a single bit, using technique described above in connection with formula (5), into a temporary variable. The variable is checked for a valid code using the technique described above in relation to formula (7). Once a valid code is found, it is placed into a pixel array. Once the array has 65,536 pixels, the computer 28 displays the data as a frame in a video image. The following pseudo-code demonstrates this:

| | |
|---|---|
| (8) | Temp = 0 |
| | Input Byte ‘Get a byte |
| | Number Bits = 8 |
| | For Pixel Count = 1 to 65,536 |

| | |
|---|---|
| Loop: | Temp = Temp * 2 + Byte * 2 ‘Shift a bit into |

the temp variable

Number Bits = Number Bits − 1
If Number Bits = 0 then

Input Byte
Number Bits = 8

Pixel = HuffCodes (Temp)

Loop While Pixel = CODE_NOT FOUND
PixelArray (Pixel Count) = Pixel

Next Pixel Count

FIG. 11 is a flowchart representing the process of formula (8). As described above, the Huffman Code array, or HuffCodes (I), was preloaded in all locations with the flag “Code_Not_Found”. The extracted bit or group of bits making the value in “Pixel” is used as an index into the array HuffCodes (I). If the group of bits in “Pixel” is not a valid intensity, the value in “HuffCodes (Pixel)” is “Code_Not_Found”, and another bit is shifted into “Pixel” and the test is made again. Such shifting is carried out in the manner described above in relation to FIG. 8. This is repeated until a valid pixel is found.

Thus, initially in step 200 a “Temp” variable is set to 0 and the computer 28 takes a byte (8 bits) of the pixel data to process. The “Number Bits” variable is set to 8, and the “Pixel Count” variable is set to 1. Next, for each pixel (where Pixel Count=1 to 65,536), in step 202, Temp is set equal to Temp*2+Byte*2 in order to shift a bit into the Temp variable. Next, the variable Number Bits is decremented by 1 in step 204. In step 206, the computer 28 checks whether Number Bits is equal to 0. If no, the computer 28 proceeds to step 208 in which the Pixel data is set to HuffCodes(Temp). Next, in step 210 the computer 28 determines if the Pixel remains equal to CODE_NOT_FOUND. If no in step 210, the PixelArray(Pixel Count) is set equal to Pixel in step 212. If yes in step 210, the process returns to step 202 and the data is shifted again and the steps repeated.

If in step 206 the NumberBits is equal to 0, indicating that no bits remain from the previous input, the computer 28 proceeds to step 214. In step 214, the next byte of data is selected, and NumberBits is reset to 8.

Following step 212, the computer 28 determines in step 216 if Pixel Count is equal to 65,536 which indicates that all pixels for the frame have been decompressed. If yes, the process continues as shown in step 218 whereby the computer 28 displays the decompressed data as a frame on the video display 36. If Pixel Count does not equal 65,536 in step 216, the Pixel Count is incremented by 1 as shown in step 220. The process then returns to step 202.

The ability to receive multiple sets of data stems from the inclusion of three software LAN sockets. These sockets allow the present invention to receive data from up to three different sources (e.g., sources 54 in FIG. 2). One of the sources may be additional compressed video data stream. Another source may be the tracking data. A third source may be reserved for future growth. These sockets can be configured to respond to available LAN data in either interrupt or polled mode. In order to complete all computations before receiving data, they are implemented in polled mode. This ensures that a complete frame of video and track data is contiguous.

A feature of the present invention is the ability to combine video and track information onto a single display. When the video is formed at compression time, a unique frame number is stored for each individual frame of data. This frame number is matched to a corresponding frame number in the tracking data frame. Because the quantity of tracking data is small compared to the video data, this data arrives before the video decompression is complete. Rather than use a complex sorting algorithm to match the track data with the video data, a technique using a data array is used. An arbitrarily large array is defined for holding the tracking data. As tracking data becomes available, the tracking parameters are entered into the array using the frame number as the index into the array. Once video frame decompression is complete, the video frame number is used as an index into the tracking array, and the associated track data is retrieved. While this necessitates some overhead in PC memory, it executes very fast.

The present invention also is capable of adjusting background contrast by taking advantage of a unique nature of the Huffman compression technique. Huffman compression assigns values to groups of one to seven bits depending on their uniformity. Most of the background is very uniform, and is stored in one to three bits. In Huffman compression, an eight bit value is an uncompressed intensity, and is associated with the targets of interest. This allows a factor to be applied to the background bits, while leaving the target intensities untouched. The following equation is used:
Pixel=(Intensity*1.25)+51 (9)

While this will work, execution is faster when the equation is implemented in integer arithmetic. The following pseudo-code fragment demonstrates the complete algorithm implemented in integer form:

| | |
|---|---|
| (10) | If Shift = 8 then |
| | Pixel = Intensity |
| Else | |
| | Pixel = Intensity + (Intensity / 4) + 51 |

The incoming telemetry data stream in the exemplary embodiment contains three different video image channels, two channels of infrared and one channel of visible video. These channels appear consecutively in the data stream. Displaying three different video images is possible using underlying routines in the predominant operating system of desktop PC's, Microsoft Windows (Windows). Windows includes a set of low level routines, called Application Interface (API) routines, for rapidly displaying and changing all visual aspects of its operating system. These routines are available as API calls to Visual Basic. The API calls are used to display three different video images. The Search routine extracts the video channel during the search for a valid synchronizing code. The three codes are for two infrared video channels and one black and white visible video channel. The implementation is similar to formula (3) above as the following pseudo-code fragment demonstrates:

| | | |
|---|---|---|
| (11) | Select | Case (Byte) |

| | |
|---|---|
| Case: | IR1 |
| | Call DisplayImage API (IR1 Image) |
| Case: | IR2 |
| | Call DisplayImage API (IR2 Image) |
| Case: | VIS |
| | Call DisplayImage API (VIS Image) |

The API call DisplayImage takes the Pixel array and displays it as an 256×256 video image at a predetermined location on the screen. Because the images are persistent and displayed in three different locations, an illusion is created that all three images are moving simultaneously.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A method for performing real-time decompression and display of Huffman compressed video data, the method comprising implementing a personal computer to carry out the steps of:
receiving the video data;
searching for a frame synchronizing code on bit boundaries of the video data;
upon detecting the frame synchronizing code for a given frame in the video data, extracting a frame number, Huffman levels and corresponding intensities from the given frame;
extracting pixel data for the given frame based on the Huffman levels and corresponding intensities; and
displaying the pixel data in real time.

2. The method of claim 1, wherein the step of searching for the frame synchronizing code comprises comparing the received data against a plurality of predefined bit configurations.

3. The method of claim 2, wherein the plurality of predefined bit configurations each represent a valid synchronization code with a corresponding shift.

4. The method of claim 3, wherein the step of extracting the frame number, Huffman levels and corresponding intensities comprises the step of multiplying the video data by a power of two based on the corresponding shift.

5. The method of claim 1, wherein the step of extracting the pixel data comprises generating the Huffman codes for each frame by presetting each value in a Huffman code array to a known value, and subsequently overwriting a value for a given entry in the Huffman code array with a valid intensity when a corresponding Huffman code from the Huffman code array is extracted from the video data.

6. The method of claim 5, wherein the Huffman code array comprises 2ⁿ values, where n is equal to the number of bits in the Huffman data.

7. The method of claim 5, wherein the video data comprises high uniformity background data.

8. The method of claim 7, wherein the video data comprises telemetry data comprising stars against blackness of space.

9. The method of claim 1, wherein the video data comprises multiple channel video data and the method is carried out with respect to each channel.

10. The method of claim 1, wherein the step of displaying the pixel data includes overlaying additional data on top of the pixel data.

11. The method of claim 1, further comprising the step of in a case where a background within the video data has high uniformity, adjusting the intensity of at least one of the background data and target data within the background to increase contrast.

12. A system comprising a personal computer and machine readable code executable by the personal computer to carry out the method in accordance with claim 1.

13. A machine-readable storage medium having machine readable information stored therein for, when read and executed by a machine, carrying out the method of claim 1.
